(19) United States
(12) Patent Application Publication
(10) Pub. No.: US 2021/0146527 A1
(43) Pub. Date: May 20, 2021

(54) EXOSKELETON JOINT DRIVE WITH NON-LINEAR TRANSMISSION

(71) Applicant: exoIQ GmbH, Hamburg (DE)

(72) Inventors: Bernward Otten, Hamburg (DE); Robert Weidner, Gerdau (DE)

(21) Appl. No.: 17/099,200

(22) Filed: Nov. 16, 2020

(30) Foreign Application Priority Data
Nov. 17, 2019 (DE) 10 2019 131 005.9

(51) Int. Cl. B25J 9/00; B25J 9/12; B25J 9/14; B25J 9/16; B25J 13/08; B25J 19/00

(52) U.S. Cl. CPC B25J 9/0006; B25J 9/126; B25J 19/0016; B25J 9/1633; B25J 13/088; B25J 9/144

(57) ABSTRACT

An exoskeleton includes a first link and a second link, wherein the first link and the second link are rotatable relative to each other about a first axis of rotation, thereby forming a first rotary joint of the exoskeleton. A joint drive has a first element and a second element. The first element is connected to the first link by a second rotary joint; the second element is connected to the second link by a linear joint; and the second element is connected to the first element by a third rotary joint.

### CROSS-REFERENCE TO RELATED APPLICATIONS

This application claims priority to German Application No. DE 10 2019 131 005.9, filed on Nov. 17, 2019, which is incorporated herein.

### FIELD

The present disclosure relates to an exoskeleton. In particular, the present disclosure relates to an exoskeleton with a joint drive.

### BACKGROUND

When using an exoskeleton, the level of assistance that is to be provided by the exoskeleton usually depends on the activity and may differ significantly between different poses and movements.

### SUMMARY

An exoskeleton may comprise a first link and a second link connected by a first rotary joint, and a joint drive with a first element and a second element. The first element may be connected to the first link by a second rotary joint. The second element may be connected to the second link by a linear joint. The second element may be connected to the first element by a third rotary joint.

The term “link”, as used in the context of the present description and the claims, may refer to a rigid body which forms part of the kinematic chain defining the exoskeleton. Furthermore, the term “element”, as used in the context of the present description and the claims, may refer to a rigid component that is configured to transmit a force applied to the component onto another component. Moreover, the term “rotary joint”, as used in the context of the present description and the claims, may refer to an arrangement in which two links/elements are connected to one another such that they can be rotated relative to one another about a common axis of rotation.

Furthermore, the term “joint drive”, as used in the context of the present description and the claims, may refer to an arrangement which is configured to control or influence an orientation of the first link relative to the second link. Furthermore, the term “linear joint”, as used in the context of the present description and the claims, may refer to an arrangement in which two elements are connected to one another such that they can be linearly moved relative to one another.

When the orientation of the first link relative to the second link changes, the second axis of rotation may be displaced relative to the second link (along a circular path) causing a change in the length of the lever between the first axis of rotation of the first rotary joint and the second axis of rotation of the second rotary joint.

A distance between the first rotary joint and the second rotary joint or a distance between the second rotary joint and the third rotary joint may be adjustable. For example, the exoskeleton may comprise an electric motor or a spindle drive which is configured to adjust the distance.

The first axis of rotation of the first rotary joint, the second axis of rotation of the second rotary joint, and a third axis of rotation of the third rotary joint are parallel.

The first element may be a push rod.

The exoskeleton may further comprise an actuator which is attached to the second link. The actuator may be a pneumatic actuator and the second element may be a piston of the pneumatic actuator.

The second element may be connected to the actuator via a transmission. A transmission ratio of the transmission may be independent of the orientation of the first link relative to the second link.

The exoskeleton may further comprise a controller which is configured to control a force applied by the actuator to the second element based on a pose of a user of the exoskeleton, a movement of the first link relative to the second link, a speed of the movement, and/or an acceleration of the movement.

The exoskeleton may further comprise a sensor which is configured to determine an angle between the first link and the second link, wherein the controller is further configured to control the actuator based on the angle.

The exoskeleton may further comprise a gyroscope or an accelerometer, wherein the controller may be further configured to control the actuator based on the measurements provided by the gyroscope and/or the accelerometer.

The first link may be an upper arm link and the second link may be a shoulder link.

The exoskeleton may further comprise a spring which is attached to the second link, wherein the second element is further connected to the second link by the spring.

The second element may have a magnetic portion and the exoskeleton comprises a magnet that limits a movement of the second element relative to the second link by magnetic force.

A method of adapting the exoskeleton to different usage scenarios may comprise determining that an increase in support force provided by the joint drive is required and increasing a distance of the first rotary joint and the second rotary joint during operation.

### BRIEF DESCRIPTION OF THE DRAWINGS

The foregoing aspects will be explained in more detail in the following detailed description based on exemplary embodiments, wherein reference is made to the drawings in which:

FIG. 1 shows a rotary joint and a joint drive of an exoskeleton;

FIG. 1a shows a pressure curve versus the angle of rotation;

FIG. 1b shows a support torque curve versus the joint angle;

FIG. 2 shows a modification of the joint drive shown in FIG. 1;

FIG. 2a shows a pressure curve versus the angle of rotation;

FIG. 2b shows a support torque curve versus the joint angle;

FIG. 3 shows a modification of the joint drive shown in FIG. 1;

FIG. 4 shows further elements of the joint drive shown in FIG. 1;

FIG. 5 shows a modification of the joint drive shown in FIG. 4;

FIG. 6 shows a flow chart for adapting the joint drive; and

FIG. 7 shows an exemplary exoskeleton.

In the drawings, the same or functionally similar elements are indicated by the same reference numerals.

### DETAILED DESCRIPTION

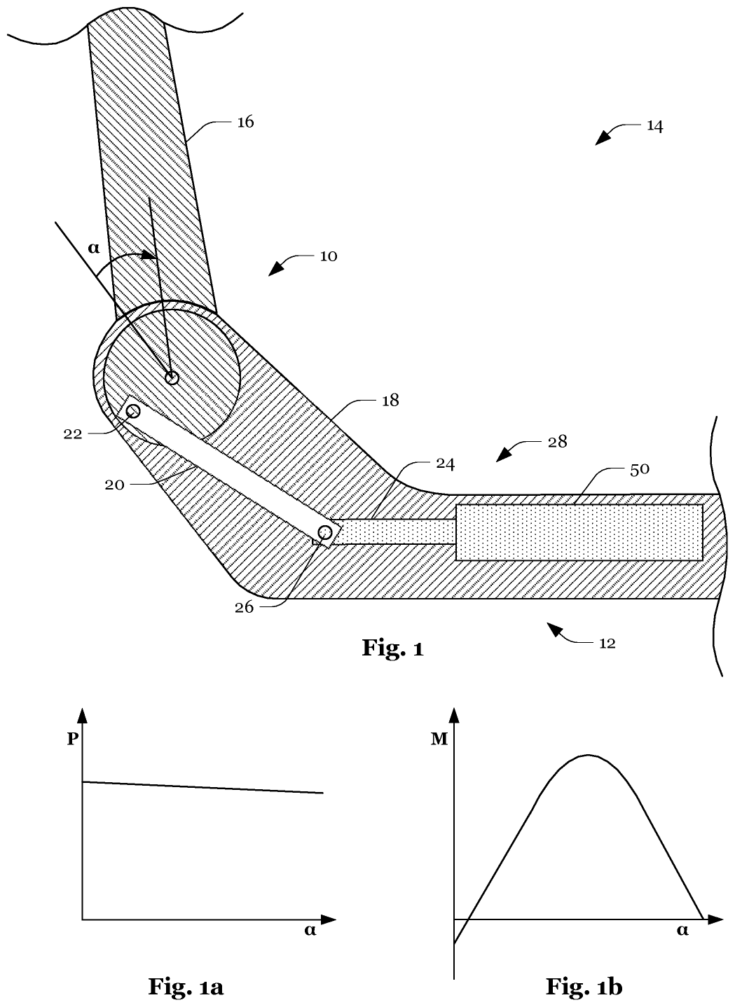

FIG. 1 shows rotary joint 10 and joint drive 12 of exoskeleton 14. Rotary joint 10 connects link 16 and link 18 which can be rotated relative to each other about a common axis of rotation. Link 18 is an angled rigid body which may be connected to a shoulder of a user. Link 16 is an elongated rigid body which may be used to support a movement of an upper arm of the user.

Joint drive 12 comprises element 20 which is designed as a push rod and is connected to link 16 by rotary joint 22. Joint drive 12 further comprises element 24 which is connected to element 20 by rotary joint 26. The axis of rotation of rotary joint 10, the axis of rotation of rotary joint 22, and the axis of rotation of rotary joint 26 are parallel and a center of rotation of rotary joint 22 moves relative to a center of rotation of rotary joint 10 on a circular path when the relative orientation between link 16 and link 18 changes.

Element 24 is connected to element 18 by linear joint 28. Moreover, element 24 serves as a piston of pneumatic actuator 50 attached to link 18. FIG. 1a illustrates the pressure P in pneumatic actuator 50 as a function of the orientation of link 16 and link 18 relative to one another. FIG. 1b illustrates the support torque M as a function of the orientation of link 16 and link 18 relative to one another.

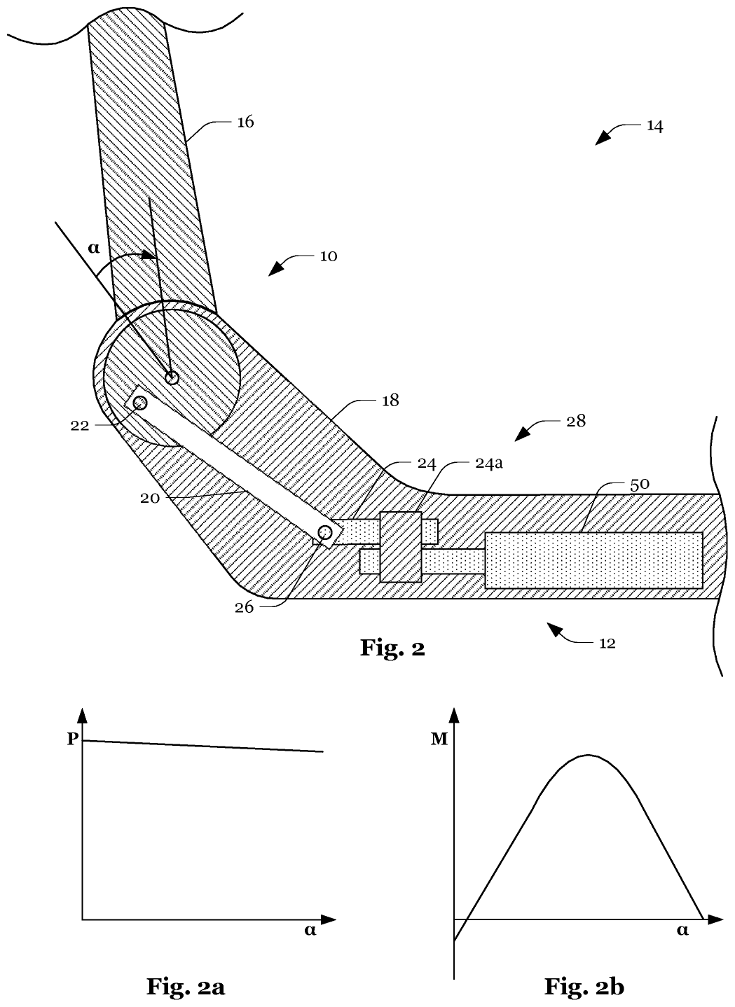

As illustrated in FIG. 2, FIG. 2a and FIG. 2c, support torque M may be adjusted (continuously) by changing the distance of the center of rotation of rotary joint 10 and the center of rotation of rotary joint 22. In addition, the zero crossing of the support torque M may be adjusted to a value al that is particularly suitable for the respective application scenario, by suitable dimensioning of element 20 and element 24. Furthermore, as shown in FIG. 2, element 24 may be connected to element 20 by transmission 24a (e.g., a gear transmission).

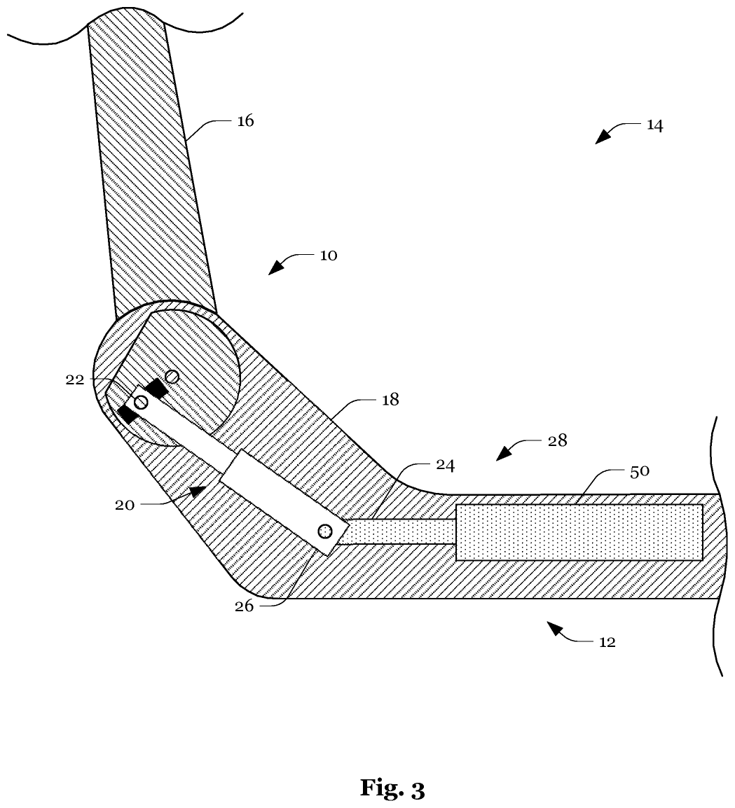

FIG. 3 shows a possible modification of the arrangements described above with reference to FIG. 1, FIG. 1a, FIG. 1b, FIG. 2, FIG. 2a and FIG. 2b. The modification allows for a (stepless) adjustment of the distance between the center of rotation of rotary joint 10 and the center of rotation of rotary joint 22 during operation (e.g., by means of an electric motor, spindle drive, etc.). Furthermore, the arrangement shown in FIG. 3 allows for a (stepless) adjustment of the length of element 20 (e.g., by means of an electric motor, spindle drive, etc.).

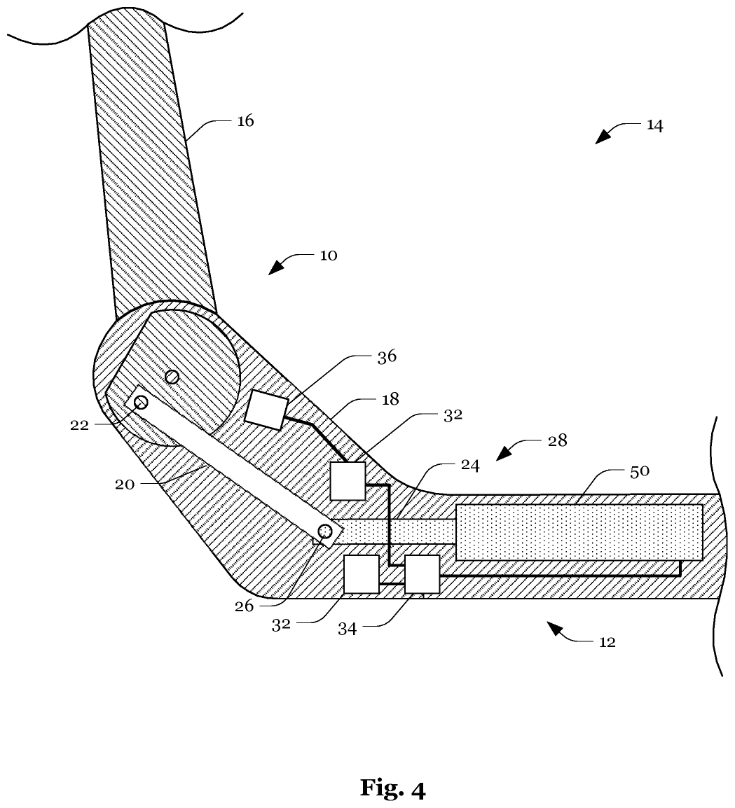

FIG. 4 shows a possible modification of the arrangements described above with reference to FIG. 1, FIG. 1a, FIG. 1b, FIG. 2, FIG. 2a, FIG. 2b and FIG. 3. The arrangement shown in FIG. 4 additionally comprises compressed air reservoir 30 and controller 32, wherein controller 32 is configured to supply or withdraw compressed air to/from pneumatic actuator 50 via a valve 34 controlled by controller 32, depending on a movement of link 16 relative to link 18, a pose that a user of the exoskeleton 14 assumes or an angular velocity or an angular acceleration.

To detect the pose, the arrangement shown in FIG. 4 comprises a sensor unit 36 with an angle of rotation sensor which is configured to determine a relative angle between link 16 and link 18. Controller 32 may be configured to supply or withdraw compressed air to/from pneumatic actuator 50 depending on the relative angle. Sensor unit 36 may further comprise a gyroscope and/or an accelerometer. The measurement of the gyroscope and/or the acceleration sensor may also be taken into account when supplying or withdrawing compressed air to/from pneumatic actuator 50.

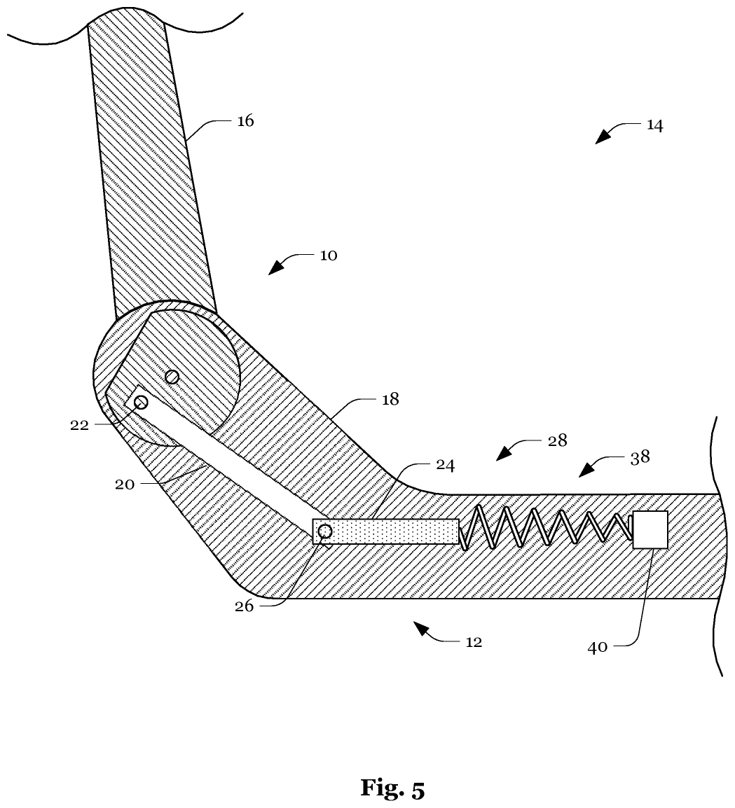

As shown in FIG. 5, element 24 may be connected to link 18 by spring 38. Alternatively or additionally, element 24 may have a magnetic section and exoskeleton 14 may comprise magnet 40 which limits a movement of element 24 relative to link 18 by means of magnetic force 12.

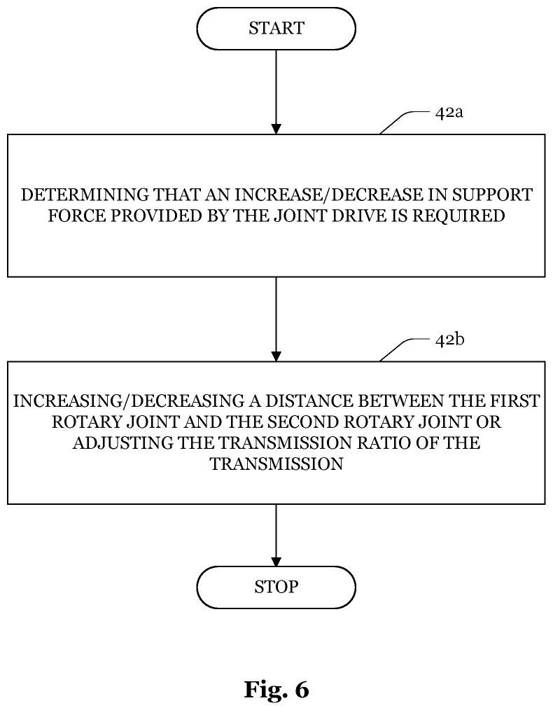

FIG. 6 shows steps 42a and 42b for adapting joint drive 12, comprising determining that an increase/decrease in support force provided by joint drive 12 is required and adjusting the distance between the center of rotation of rotary joint 10 and the center of rotation of rotary joint 22 or changing the transmission ratio of transmission 24a.

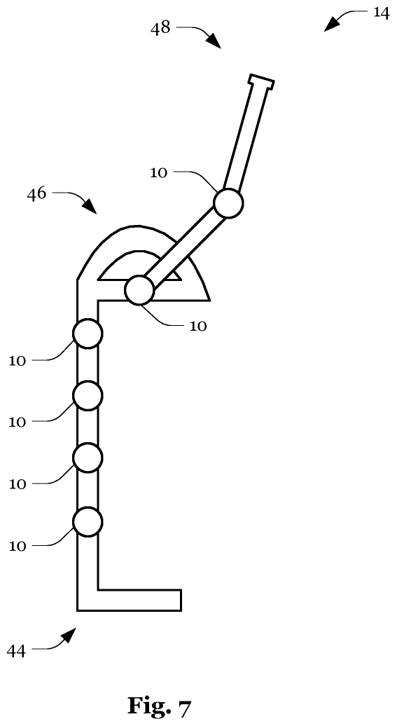

FIG. 7 shows an exoskeleton 14 with a plurality of rotary joints 10. Exoskeleton 14 comprises pelvis connector 44 (for example a pelvic belt), shoulder connector 46 (for example a shoulder belt) and arm connector 48 (for example an arm belt). One, two or more rotary joints 10 may be provided with one of the joint drives 12 described above.

### LIST OF REFERENCE SIGNS

10 rotary joint
12 joint drive
14 exoskeleton
16 link
18 link
20 element
22 rotary joint
24 element
24a transmission
26 rotary joint
28 linear joint
30 compressed air reservoir
32 controller
34 valve
36 sensor unit
38 spring
40 magnet
42a step
42b step
44 pelvis connector
46 shoulder connector
48 arm connector
50 actuator

1. An exoskeleton, comprising:
a first link and a second link, wherein the first link and the second link are rotatable relative to each other about a first axis of rotation, thereby forming a first rotary joint of the exoskeleton; and
a joint drive with a first element and a second element;
wherein the first element is connected to the first link by a second rotary joint;
wherein the second element is connected to the second link by a linear joint; and
wherein the second element is connected to the first element by a third rotary joint.

2. The exoskeleton of claim 1, wherein a second axis of rotation of the second rotary joint is displaced relative to the second link along a circular path when an orientation of the first link relative to the second link changes.

3. The exoskeleton of claim 1, wherein a length of a lever between the first axis of rotation of the first rotary joint and a second axis of rotation of the second rotary joint changes when an orientation of the first link relative to the second link changes.

4. The exoskeleton of claim 1, wherein a distance between the first rotary joint and the second rotary joint is adjustable.

5. The exoskeleton of claim 4, further comprising:
one of an electric motor or a spindle drive which is configured to adjust the distance between the first rotary joint and the second rotary joint.

6. The exoskeleton of claim 1, wherein a distance between the second rotary joint and the third rotary joint is adjustable.

7. The exoskeleton of claim 6, further comprising:
one of an electric motor or a spindle drive which is configured to adjust the distance between the second rotary joint and the third rotary joint.

8. The exoskeleton of claim 1, wherein the first axis of rotation of the first rotary joint, a second axis of rotation of the second rotary joint and a third axis of rotation of the third rotary joint are parallel.

9. The exoskeleton of claim 1, wherein the first element is a push rod.

10. The exoskeleton of claim 1, further comprising:
an actuator which is attached to the second link.

11. The exoskeleton of claim 10, wherein the actuator is a pneumatic actuator.

12. The exoskeleton of claim 11, wherein the second element is a piston of the pneumatic actuator.

13. The exoskeleton of claim 10, wherein the second element is connected to the actuator via a transmission.

14. The exoskeleton of claim 13, wherein a transmission ratio of the transmission is independent of an orientation of the first link relative to the second link.

15. The exoskeleton of claim 10, further comprising:
a controller which is configured to control a force applied by the actuator to the second element based on at least one of a pose of a user of the exoskeleton, a movement of the first link relative to the second link, a speed of the movement, or an acceleration of the movement.

16. The exoskeleton of claim 15, further comprising:
a sensor which is configured to determine an angle between the first link and the second link, wherein the controller is further configured to control the actuator based on the angle.

17. The exoskeleton of claim 15, further comprising:
at least one of a gyroscope and an accelerometer, wherein the controller is further configured to control the actuator based on measurements provided by at least one of the gyroscope or the accelerometer.

18. The exoskeleton of claim 1, wherein the first link is an upper arm link and the second link is a shoulder link.

19. The exoskeleton of claim 1, further comprising:
a spring which is attached to the second link, wherein the second element is further connected to the second link by the spring.

20. The exoskeleton of claim 1, wherein the second element has a magnetic portion and the exoskeleton comprises a magnet that limits a movement of the second element relative to the second link by magnetic force.

21. A method of adapting an exoskeleton according to claim 4 to different usage scenarios, comprising:
determining that an increase in support force provided by the joint drive is required; and
increasing a distance of the first rotary joint and the second rotary joint during operation.
